(19) United States
(12) Patent Application Publication
(10) Pub. No.: US 2026/0133055 A1
(43) Pub. Date: May 14, 2026

(54) ACTUATOR DEVICE AND METHOD

(71) Applicant: Festo SE & Co. KG, Esslingen (DE)

(72) Inventors: Holger BOHM, Waldstetten (DE); Gabriel DÄMMER, Esslingen (DE); Daniel KLASSEN, Esslingen (DE)

(21) Appl. No.: 19/385,816

(22) Filed: Nov. 11, 2025

(30) Foreign Application Priority Data
Nov. 12, 2024 (DE) 10 2024 133 095.3

(51) Int. Cl. G01D 5/14; H02K 11/215

(52) U.S. Cl. CPC G01D 5/145; H02K 11/215

(57) ABSTRACT

An actuator device including a magnetic field sensor device and a drive arrangement for performing a drive movement. The drive arrangement has a rotary movement part which includes a first magnetic element and, as part of the drive movement, changes its rotational position relative to the magnetic field sensor device over a rotational position angle range of more than one revolution, and a linear movement part coupled to the rotary movement part, which includes a second magnetic element and performs a linear movement relative to the magnetic field sensor device as part of the drive movement. The magnetic field sensor device is configured to detect the magnetic fields of the first magnetic element and the second magnetic element. The actuator device further includes an evaluation unit which is configured to determine a rotational position of the rotary movement part that is unambiguous with respect to the rotational position angle range.

### CROSS-REFERENCE TO RELATED APPLICATION

This application claims priority to German application no. 10 2024 133 095.3 filed Nov. 12, 2024, which is incorporated by reference.

### BACKGROUND

The invention relates to an actuator device for industrial automation, in particular a pneumatic swivel drive or a pneumatic gripper, comprising a magnetic field sensor device and a drive arrangement for performing a drive movement, wherein the drive arrangement has a rotary movement part which comprises a first magnetic element and, within the drive movement, changes its rotational position relative to the magnetic field sensor device over a rotational position angle range of more than one revolution, wherein the drive arrangement further comprises a linear movement part which is motion-coupled to the rotary movement part.

For example, the linear movement part is a pneumatically actuated piston arrangement which forms a rack and pinion gear, in particular a pinion drive, with the rotary movement part. An actuator device with a rotary position angle range of more than one revolution can also be referred to as a multi-turn actuator device.

### SUMMARY

It is an object of the invention to determine an unambiguous rotational position of the rotary movement part with respect to the rotational position angle range, i.e., with respect to an angle range that comprises more than one revolution, i.e., more than 360 degrees. The unambiguous rotational position may also be referred to as unique rotational position.

The object is solved by an actuator device according to claim 1. The actuator device comprises a second magnetic element which, as part of the drive movement, performs a linear movement relative to the magnetic field sensor device, wherein the magnetic field sensor device is configured to detect the magnetic fields of the first magnetic element and the second magnetic element, and the actuator device further comprises an evaluation unit which is configured to determine an unambiguous rotational position of the rotary movement part with respect to the rotational position angle range on the basis of the detected magnetic fields.

The formulation that the magnetic field sensor device detects the magnetic fields of the first magnetic element and the second magnetic element means in particular that the magnetic field of the first magnetic element and the magnetic field of the second magnetic element are included in the magnetic field detection performed by the magnetic field sensor device, i.e., for example, that the magnetic field sensor device detects a total magnetic field resulting from a superposition of the magnetic field of the first magnetic element and the magnetic field of the second magnetic element.

The linear movement of the second magnetic element relative to the magnetic field sensor device causes a change in the magnetic field of the second magnetic element detected at the location of the magnetic field sensor device. Since the rotary movement part and the linear movement part are motion-coupled and the linear movement of the linear movement part is therefore related to the rotary movement of the rotary movement part, the detected magnetic field of the second magnetic element can be used to detect the revolution in which the rotary movement part is. Consequently, a rotational position of the rotary movement part that is unambiguous (i.e. unique) with respect to the rotational position angle range can be determined.

Preferably, the first magnetic element rotates and the second magnetic element is moved linearly, wherein the magnetic fields of the two magnetic elements overlap and are detected in particular by a single sensor element, so that a unique assignment between a sensor signal of the sensor element and a system state of the drive arrangement is possible over the entire range of movement-in particular, the entire rotational position angle range.

In the manner described above, the evaluation unit can preferably determine the unambiguous rotational position directly when the actuator device is switched on-thus enabling true power-on for a multi-turn actuator device.

Advantageous further developments are the subject of the dependent claims.

The invention further relates to a method of operating the actuator device, comprising the steps of:
performing the drive movement,
detecting the magnetic fields of the first magnetic element and the second magnetic element with the magnetic field sensor device, and
determining the unambiguous rotational position with the evaluation unit on the basis of the detected magnetic fields.

### BRIEF DESCRIPTION OF THE DRAWINGS

Further exemplary details and exemplary embodiments are explained below with reference to the figures.

FIG. 1 shows a schematic representation of an actuator device,

FIG. 2 shows a graph showing curves of a first magnetic field value and a second magnetic field value,

FIG. 3 a further graph showing curves of a first magnetic field value and a second magnetic field value, and

FIG. 4 a further diagram showing the curves of a first magnetic field value and a second magnetic field value.

### DETAILED DESCRIPTION

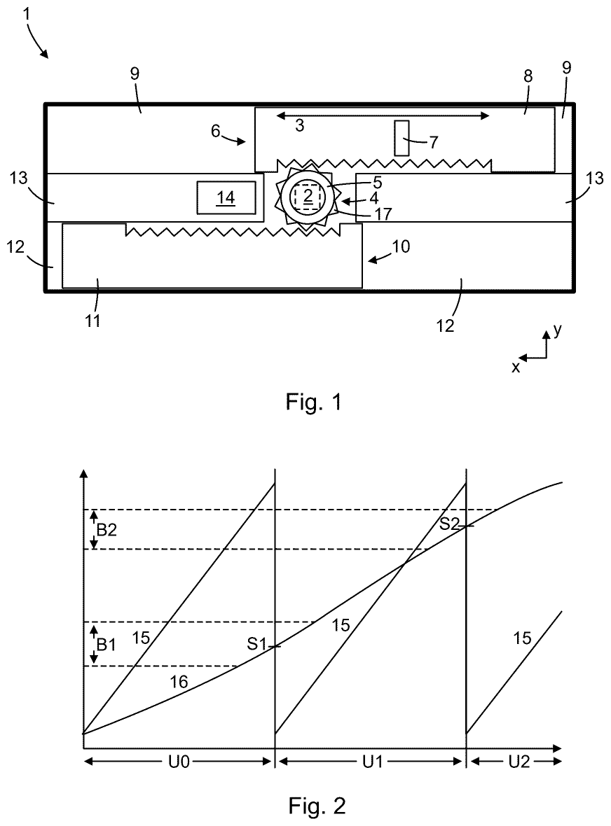

FIG. 1 shows an exemplary embodiment of an actuator device 1 for industrial automation. Purely by way of example, the actuator device 1 is designed as a pneumatic actuator device.

The actuator device 1 comprises a drive arrangement for performing a drive movement 3. The drive arrangement comprises a rotary movement part 4 and at least one linear movement part 6 that is motion-coupled to the rotary movement part 4. The linear movement part 6 is coupled to the rotary movement part 4 in such a way that the rotary movement part 4 performs a rotary movement when the linear movement part 6 performs a linear movement. The drive movement 3 is, for example, the linear movement of the linear movement part 6. Alternatively, the drive movement can be the rotary movement of the rotary movement part 4 or another movement.

The linear movement is exemplarily performed along an x-direction. The rotary movement is exemplarily performed about a rotary axis that is oriented in particular in the z-direction. The z-direction runs perpendicular to the drawing plane. Reference will also be made to a y-direction in the following. The x-direction, y-direction, and z-direction are oriented orthogonally to one another.

The drive arrangement is exemplarily designed as a rack and pinion gear, in particular as a pinion drive. The rotary movement part 4 comprises a gear wheel 17 and the linear movement part 6 comprises a rack 8 engaging with the gear wheel 17.

The drive arrangement is preferably designed as a pneumatic drive arrangement. The linear movement part 6 is designed as a piston arrangement, for example. The actuator device 1 comprises at least one pressure chamber 9, which acts pneumatically on the linear movement part 6 and via whose pneumatic actuation the drive movement-and thus the linear movement and/or rotary movement-can be effected. By way of example, the actuator device 1 has two pressure chambers 9, which act pneumatically on the linear movement part 6.

Purely as an example, the drive arrangement has a further linear movement part 10, which is expediently designed as a piston arrangement and comprises a further rack 11 engaging with the gear wheel 17. The additional linear movement part 10 can be driven, for example, by means of at least one additional pressure chamber 12, in particular by means of two additional pressure chambers 12.

For example, the actuator device 1 has one or more wall structures 13, by means of which the one or more pressure chambers 9, 12 are bounded.

The actuator device 1 comprises a magnetic field sensor device 2, which is shown in FIG. 1 with dashed lines. The magnetic field sensor device is preferably designed as a magnetic field sensor element, in particular as a 3D Hall sensor. The magnetic field sensor device 2 is arranged in (or on) the actuator device 1 in such a way that it is stationary relative to the rotary movement part 4 and/or stationary relative to the linear movement part 6. The magnetic field sensor device 2 therefore does not move with the rotary movement of the rotary movement part 4 and with the linear movement of the linear movement part 6.

The rotary movement part 4 comprises a first magnetic element 5, which is designed as a ring magnet, for example. The first magnetic element 5 is a permanent magnet. The ring magnet is oriented in particular coaxially with the axis of rotation of the rotary movement part 4. The first magnetic element 5 is magnetized in particular diametrically. For example, the direction of magnetization of the first magnetic element 5 runs perpendicular to the axis of rotation of the rotary movement part 4, i.e., it lies in particular in an x-y plane.

During drive movement 3, the rotary movement part 4—and thus also the first magnetic element 5—changes its rotational position relative to the magnetic field sensor device 2 over a rotational angle range of more than one revolution. The rotational angle range thus extends from 0 to more than 360 degrees, for example from 0 to 720 degrees, or even more. Adjoining sub-ranges of the rotational position angle range, each extending over exactly 360 degrees, shall also be referred to as revolutions and referenced with consecutive revolution numbers, wherein the first sub-range—i.e. the range from 0 to 360 degrees—shall be assigned the revolution number “0”. The last sub-range may also comprise less than 360 degrees, in particular if the rotational angle range is not an integer multiple of 360 degrees.

The linear movement part 6 comprises a second magnetic element 7. The second magnetic element 7 is a permanent magnet. As part of the drive movement, the linear movement part 6—and thus also the second magnetic element 7—performs the linear movement relative to the magnetic field sensor device 2. The second magnetic element 7 can, for example, be designed as a ring magnet and is preferably oriented with its ring axis in the axial direction of the linear movement. Preferably, the second magnetic element 7 is magnetized axially. In particular, the magnetization direction of the second magnetic element 7 runs in the x-direction. Preferably, the magnetization direction of the second magnetic element 7 is orthogonal to the magnetization direction of the first magnetic element 4.

As already mentioned above, the actuator device 1 can be designed, for example, as a pneumatic swivel drive or as a pneumatic gripper. In a design as a pneumatic swivel drive, a shaft is expediently driven by means of the rotary movement part 4, or the rotary movement part 4 is designed as a shaft to be driven. The pneumatic swivel drive serves, for example, to actuate a valve, in particular a process valve. Preferably, an arrangement is provided which comprises a valve and the actuator device 1, wherein the actuator device 1 serves to actuate the valve with the drive movement. In a design as a pneumatic gripper, a gripping section, in particular a gripping finger, is arranged on the linear movement element 6, for example, which can be set in a gripping movement by the drive movement.

The magnetic field sensor device 2 is configured to detect the magnetic fields of the first magnetic element 5 and the second magnetic element 7. The magnetic field of the first magnetic element 5 shall also be referred to as the first magnetic field and the magnetic field of the second magnetic element 7 as the second magnetic field. The two magnetic fields superimpose each other in the magnetic field sensor device 2, in particular in the magnetic field sensor element. Preferably, the magnetic field sensor element is configured to measure the magnetic field strength of the superimposed magnetic fields of the first magnetic element 5 and the second magnetic element 7 (in the magnetic field sensor element), in particular in several spatial directions, for example in three spatial directions that are oriented orthogonally to each other. In this way, the magnetic fields of the magnetic elements 5, 6 can be detected.

The actuator device comprises an evaluation unit 14, which is designed, for example, as a computing unit, in particular as a microcontroller. The evaluation unit 14 is communicatively connected to the magnetic field sensor device 2 and receives one or more magnetic field sensor signals from the magnetic field sensor device 2. According to an alternative design, the evaluation unit can be integrated into the magnetic field sensor device, or the magnetic field sensor device can be integrated into the evaluation unit.

The evaluation unit 14 is configured to determine, on the basis of the detected magnetic fields, an unambiguous (i.e. unique) rotational position of the rotary movement part 4 with respect to the rotational position angle range. An unambiguous rotational position is defined as a rotational position that corresponds to only a single angle of the rotational position angle range. As already mentioned above, the rotational position angle range extends over more than one revolution, i.e., over more than 360 degrees. The unambiguous (or unique) rotational position can also be referred to as the absolute rotational angle.

The evaluation unit 14 expediently provides rotational position information that contains the determined unique rotational position, for example as a numerical value. Optionally, the evaluation unit 14 outputs the rotational position information, for example as an output signal.

The term “rotational orientation” refers to the rotational angle of the rotational movement part 4 within one revolution, i.e., the rotational angle within a range from 0 to 360 degrees. For each revolution, the rotational orientation begins at 0 degrees and ends at 360 degrees. The rotational orientation is not unique (i.e. not unambiguous) in relation to the rotational position angle range (comprising several revolutions), since the same rotational orientation can occur in different revolutions.

The evaluation unit 14 is preferably configured to provide, in particular to determine, a first magnetic field value and a second magnetic field value by using the magnetic field sensor device 2. The first magnetic field value depends on the rotational orientation of the first magnetic element 5. For example, the first magnetic field value indicates the rotational orientation of the first magnetic element 5. In particular, the magnetic field sensor device 2 measures a magnetic field strength in the x-direction and a magnetic field strength in the y-direction, and the evaluation unit 14 calculates the rotational orientation of the first magnetic element 5 (around the axis of rotation extending in the z-direction) on the basis of these magnetic field strengths.

The second magnetic field value depends on the distance between the second magnetic element 7 and the magnetic field sensor device 2. Optionally, the second magnetic field value indicates the distance between the second magnetic element 7 and the magnetic field sensor device 2. For example, the second magnetic field value is a magnetic field strength, in particular in the z-direction.

Preferably, the first magnetic field value is based (in particular exclusively) on a first magnetic field component (measured by the magnetic field sensor device 2), for example the magnetic field strength in the x-direction, and a second magnetic field component (measured by the magnetic field sensor device 2), for example the magnetic field strength in the y-direction. Preferably, the second magnetic field value is based (in particular exclusively) on a third magnetic field component (measured by the magnetic field sensor device 2), for example the magnetic field strength in the z-direction. The first magnetic field component, the second magnetic field component, and the third magnetic field component are preferably oriented orthogonally to each other. This means in particular that the spatial directions in which these magnetic field components are measured are oriented orthogonally to each other. Preferably, the first magnetic field component and the second magnetic field component are oriented orthogonally to the axis of rotation of the rotary movement part 4—i.e., orthogonally to the z-direction, for example—and/or the third magnetic field component is oriented in the axial direction of the axis of rotation of the rotary movement part—i.e., in the z-direction, for example.

Preferably, the evaluation unit 14 is configured to determine the unambiguous rotational position of the rotary movement part 4 on the basis of the first magnetic field value and the second magnetic field value.

For example, the evaluation unit 14 is configured to provide (in particular to determine) the rotational orientation of the rotary movement part 4 on the basis of the detected first magnetic field value and to determine a revolution number of the rotary movement part 4 on the basis of the detected second magnetic field value. The revolution number indicates within which revolution of the rotational position angle range the rotary movement part 4 is. The evaluation unit 14 is configured to determine the unambiguous rotational position based on the rotational orientation and the revolution number.

With reference to the diagram shown in FIG. 2, an exemplary procedure for determining the unambiguous rotational position is explained.

The rotational position angle range is plotted on the horizontal axis, which in this example comprises approximately 2.5 revolutions: a first revolution U0, a second revolution U1, and a third revolution U2. The vertical axis shows a first course 15 of the first magnetic field value (exemplarily as rotational orientation) and a second course 16 of the second magnetic field value. The first course 15 repeats periodically for each (full) revolution, in particular from 0 degrees to 360 degrees. The second course 16 increases monotonically over the entire rotational position angle range. The second magnetic field value expediently primarily maps the magnetic field strength provided by the second magnetic element 7. For example, the second magnetic element 7 moves toward the magnetic field sensor device 2 as the rotational position of the rotational movement element 4 increases (in particular monotonically), preferably over the entire rotational position angle range.

The evaluation unit 14 expediently has a respective transition threshold value S1, S2 for each transition from one revolution to the next revolution, wherein the respective transition threshold value corresponds to the respective second magnetic field value at which this transition occurs.

A transition from one revolution to the next revolution shall also be referred to as a revolution transition.

The evaluation unit 14 compares the second magnetic field value with the one (or more) transition threshold values S1, S2 in order to determine in which revolution the rotary movement part 4 is and to provide the revolution number associated with this revolution. If the second magnetic field value is smaller than the first transition threshold value S1, the evaluation unit 14 provides the revolution number “0”. If the second magnetic field value is greater than the first transition threshold value S1 and less than the second transition threshold value S2, the evaluation unit 14 provides the revolution number “1”. If the second magnetic field value is greater than the second transition threshold value S2, the evaluation unit 14 provides the revolution number “2”.

The evaluation unit 14 multiplies the provided revolution number by 360 degrees and adds the rotational orientation (in degrees) to the result in order to calculate the unambiguous rotational position.

According to a preferred embodiment, the third magnetic field component is smaller, in particular significantly smaller, than the first magnetic field component and the second magnetic field component. In this way, a potentially disruptive influence of the second magnetic element 7 on the measurement of the rotational orientation can be reduced. If the third magnetic field component is designed to be smaller, noise may occur in the detected third magnetic field component. In the following, with reference to FIG. 2, an approach will be explained which serves in particular to prevent this noise from distorting the determination of the unambiguous rotational position.

Preferably, the evaluation unit 14 is configured to determine the revolution number taking into account the first magnetic field value. For example, the evaluation unit 14 is configured to determine two consecutive revolution number candidates based on the detected second magnetic field value and to select one of the two revolution number candidates as the revolution number based on the detected first magnetic field value.

For example, one or more transition ranges B1, B2 are defined in the evaluation unit 14 for the second magnetic field value, wherein each transition range B1, B2 contains a respective second magnetic field value at which a transition from one revolution to the next revolution takes place. For example, the first transition range B1 contains the second magnetic field value at which the transition from the first revolution U0 to the second revolution U1 occurs, and the second transition range B2 contains the second magnetic field value at which the transition from the second rotation U1 to the third rotation U2 occurs.

Each transition range B1, B2 comprises a respective continuous value interval. The transition ranges B1, B2 are spaced apart from each other. For example, each transition range B1, B2 comprises those values that a noisy second magnetic field value can assume at the respective transition from one revolution to the next revolution.

In response to a second magnetic field value being below the first transition range B1, the evaluation unit 14 concludes that the revolution number is equal to 0. The evaluation unit 14 multiplies the revolution number by 360 degrees and adds the rotational orientation to the result to calculate the unique rotational position.

In response to a second magnetic field value being within the first transition range B1, the evaluation unit 14 determines the numbers “0” and “1” as revolution number candidates. The evaluation unit 14 uses the rotational orientation to check which of the two revolution number candidates applies. For example, the evaluation unit 14 compares the rotational orientation with a rotational orientation threshold value, in particular 180 degrees. In response to the rotational orientation being greater than the rotational orientation threshold value, the evaluation unit 14 selects the smaller of the two revolution numbers candidates as the revolution number, in the current example “0”. In response to the rotational orientation being less than the rotational orientation threshold value, the evaluation unit 14 selects the larger of the two revolution number candidates as the revolution number, in the current example “1”. The evaluation unit 14 multiplies the selected revolution number by 360 degrees and adds the rotational orientation to the result to calculate the unambiguous rotational position.

The evaluation unit 14 handles the other possible cases in a corresponding manner. If the second magnetic field value is between the transition ranges B1 and B2, the evaluation unit 14 concludes that the revolution number is “1”. If the second magnetic field value is within the second transition range B2, the evaluation unit 14 uses the rotational orientation to decide whether the revolution number is “1” or “2”. If the second magnetic field value is above the second transition range B2, the evaluation unit 14 concludes that the revolution number is “2”. In each of these cases, the evaluation unit 14 multiplies the determined revolution number by 360 degrees and adds the rotational orientation to the result in order to calculate the unambiguous rotational position.

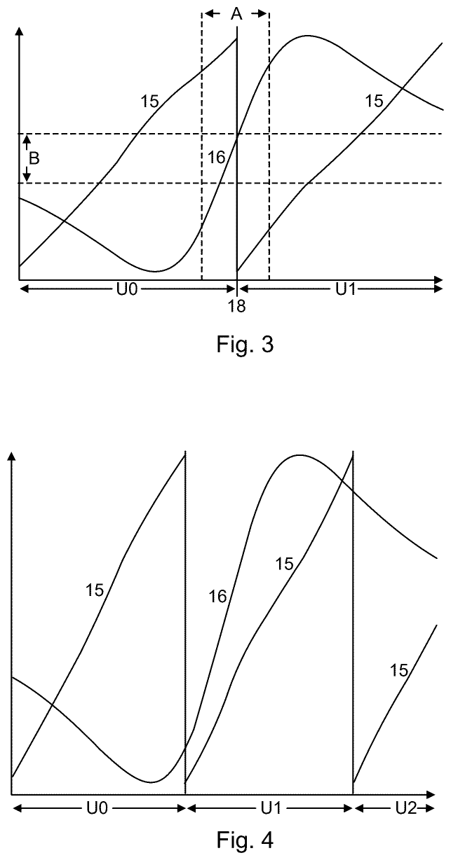

With reference to FIG. 3, an embodiment will be discussed in which the second magnetic element 7 can move past the magnetic field sensor device 2. In this case, a sign change of the third magnetic field component or the second magnetic field value can occur in particular.

In the diagram in FIG. 3, the rotational position angle range is plotted on the horizontal axis, which here comprises two revolutions U0, U1. The first course 15 of the first magnetic field value and the second course 16 of the second magnetic field value are plotted on the vertical axis.

During the drive movement 3, the second magnetic element 7 is moved past the magnetic field sensor device 2 within a transition section A of the rotational position angle range.

Within the transition section A, there is a transition 18 from one revolution U0 of the rotary movement part 4 to the next revolution U1.

The evaluation unit 14 is configured to determine the revolution number within the transition section A, taking into account the first magnetic field value.

For example, a transition range B for the second magnetic field value is defined in the evaluation unit 14. The transition range B contains the second magnetic field value at which the transition 18 from the revolution U0 to the next revolution U1 takes place. The transition range B comprises, in particular, those values that a noisy second magnetic field value can assume at the transition 18 from revolution UO to the next revolution U1.

In response to the fact that a detected second magnetic field value is outside transition range B and is negative, the evaluation unit 14 concludes that the revolution number is equal to 0. The evaluation unit 14 determines the rotational orientation as the unambiguous rotational position.

In response to the fact that a second magnetic field value detected is within the transition range B, the evaluation unit 14 determines the numbers “0” and “1” as revolution number candidates. The evaluation unit 14 checks which of the two revolution number candidates applies based on the rotational orientation. For example, the evaluation unit 14 compares the rotational orientation with a rotational orientation threshold value, in particular 180 degrees. In response to the rotational orientation being greater than the rotational orientation threshold value, the evaluation unit 14 selects the smaller of the two revolution number candidates as the revolution number, in the current example “0”. In response to the rotational orientation being less than the rotational orientation threshold value, the evaluation unit 14 selects the larger of the two revolution number candidates as the revolution number, in the current example “1”. The evaluation unit 14 multiplies the selected revolution number by 360 degrees and adds the rotational orientation to the result to calculate the unambiguous rotational position.

In response to the fact that a detected second magnetic field value is outside the transition range B and is positive, the evaluation unit 14 concludes that the revolution number is equal to 1. The evaluation unit 14 adds the rotational orientation to 360 degrees to calculate the unambiguous rotational position.

Optionally, the evaluation unit 14 is configured to perform linearization and/or temperature compensation of the first magnetic field value and/or the second magnetic field value.

In the following, with reference to FIG. 4, a further approach will be explained which can be used in particular when the rotational position angle range comprises more than two revolutions.

In the diagram in FIG. 4, the rotational position angle range is plotted on the horizontal axis, which here comprises three revolutions U0, U1, U2. The first course 15 of the first magnetic field value and the second course 16 of the second magnetic field value are plotted on the vertical axis.

Preferably, the evaluation unit 14 has a look-up table comprising a plurality of value pairs from a respective first magnetic field value and a respective second magnetic field value, as well as a plurality of rotational position values, wherein each value pair is assigned to a respective rotational position value. Each rotational position value corresponds to a respective unambiguous rotational position. The evaluation unit 14 is configured to determine the unambiguous rotational position by using the look-up table.

The value pairs stored in the look-up table, first magnetic field values and second magnetic field values, shall also be referred to as “stored value pairs”, “stored first magnetic field values” and “stored second magnetic field values”. The value pairs (consisting of first magnetic field values and second magnetic field values) detected by the magnetic sensor device 2, first magnetic field values and second magnetic field values shall also be referred to as “detected value pairs”, “detected first magnetic field values” and “detected second magnetic field values”.

The look-up table is created, for example, by calculating or simulating or by an iterative approach to reference points and corresponding measurements.

Preferably, the look-up table comprises a finer gradation (in particular, with respect to the rotational position values) in areas where there is a jump in the course of the first magnetic field value—i.e., in particular at transitions from one revolution to the next—than in other areas.

The look-up table is stored, for example, in a memory of the evaluation unit 14.

Expediently, the second magnetic field value is temperature-compensated.

Expediently, the evaluation unit 14 performs an interpolation (e.g., linear or spline) if a detected value pair comprising the first magnetic field value and the second magnetic field value lies between two value pairs stored in the look-up table.

Preferably, the evaluation unit 14 searches the look-up table for a suitable pair of values using the least squares method in order to determine the unambiguous rotational position.

As mentioned above, the first magnetic field value is, for example, the rotational orientation of the rotational movement element 4, and the second magnetic field value is, for example, the detected z-magnetic field component.

For example, for a detected first magnetic field value and a detected second magnetic field value, the evaluation unit 14 selects the stored value pair for which the deviation between the detected first magnetic field value and the stored first magnetic field value and the deviation between the detected second magnetic field value and the stored second magnetic field value are smallest. Based on this selected stored pair of values and a directly adjacent pair of values, the evaluation unit 14 then performs an interpolation of the rotational position values assigned to these pairs of values in order to calculate the unambiguous rotational position.

The following section discusses a case in which, at a transition from one revolution to the next—i.e., where the course of the rotational orientation comprises a jump from 360 degrees to 0 degrees—an intermediate value, in particular a value less than 360 degrees (preferably less than 350 degrees) and greater than 0 degrees (preferably greater than 10 degrees) is incorrectly detected as the first magnetic field value, i.e., as the rotational orientation. This case shall be referred to as the intermediate value case. Such an intermediate value can occur in particular when an analog sensor element is used as the magnetic field sensor device 2, whose detected signal (which maps the rotational orientation) can only rise or fall at a finite speed.

The evaluation unit 14 is configured to recognize this intermediate value case, in which an intermediate value is (incorrectly) detected for the first magnetic field value during a rotation transition, by the fact that the detected value pair comprising the detected first magnetic field value and the detected second magnetic field value does not match any stored value pair. For this purpose, the evaluation unit 14 is configured to, for example, check whether a deviation between a detected value pair and stored value pairs (in particular all stored value pairs or a selection of stored value pairs) exceeds a predetermined limit value. For example, for each stored value pair whose first magnetic field value is equal to the detected first magnetic field value (or lies within a tolerance range of the detected first magnetic field value), the evaluation unit 14 checks whether a deviation between the detected second magnetic field value and the stored second magnetic field value exceeds a predetermined limit value. If the deviation exceeds the limit value, the evaluation unit 14 concludes that the intermediate value case is present.

In response to the detected intermediate value case, the evaluation unit 14 identifies, on the basis of the second magnetic field value, the rotation transition that best matches the detected second magnetic field value, for example by using the look-up table. In particular, the evaluation unit 14 identifies the rotation transition whose assigned (stored) second magnetic field value is closest to the detected second magnetic field value. In particular, those entries in the look-up table whose rotational position value is 360 degrees or an integer multiple of 360 degrees are to be considered rotational transitions.

The evaluation unit 14 is configured to provide the rotational position value of this identified rotational transition as the unambiguous rotational position.

Optionally, the evaluation unit 14 is configured to correct the detected rotational orientation to 0 degrees in response to the intermediate value being less than 180 degrees and to select the larger of the two revolution numbers associated with the identified rotation transition for determining the unambiguous rotational position. Furthermore, the evaluation unit 14 is configured to correct the detected rotational orientation to 360 degrees in response to the intermediate value being greater than 180 degrees and to select the smaller of the two revolution numbers associated with the identified rotation transition for determining the unambiguous rotational position. The evaluation unit 14 then multiplies the selected revolution number by 360 degrees and adds the corrected rotational orientation to the result.

1. An actuator device for industrial automation, comprising:
a magnetic field sensor device and a drive arrangement for performing a drive movement,
wherein the drive arrangement has a rotary movement part which comprises a first magnetic element and, within the drive movement, changes a rotational position relative to the magnetic field sensor device over a rotational position angle range of more than one revolution,
wherein the drive arrangement further comprises a linear movement part coupled to the rotary movement part,
wherein the linear movement part comprises a second magnetic element and performs a linear movement relative to the magnetic field sensor device as part of the drive movement,
wherein the magnetic field sensor device is configured to detect the magnetic fields of the first magnetic element and the second magnetic element, and
the actuator device further comprises an evaluation unit which is configured to determine, on the basis of the detected magnetic fields, a rotational position of the rotary movement part which is unambiguous with respect to the rotational position angle range.

2. The actuator device according to claim 1, wherein the evaluation unit is configured to provide, using the magnetic field sensor device, a first magnetic field value and a second magnetic field value, wherein the first magnetic field value depends on a rotational orientation of the first magnetic element and the second magnetic field value depends on a distance between the second magnetic element and the magnetic field sensor device, and to determine the unambiguous rotational position based on the first magnetic field value and the second magnetic field value.

3. The actuator device according to claim 2, wherein the evaluation unit is configured to provide the rotational orientation of the rotary movement part based on the detected first magnetic field value and to determine a revolution number of the rotary movement part based on the detected second magnetic field value, wherein the revolution number indicates within which revolution of the rotational position angle range the rotary movement part is, and the evaluation unit is configured to determine the unambiguous rotational position based on the rotational orientation and the revolution number.

4. The actuator device according to claim 3, wherein the evaluation unit is configured to determine the revolution number taking into account the first magnetic field value.

5. The actuator device according to claim 4, wherein the evaluation unit is configured to determine two consecutive revolution number candidates based on the detected second magnetic field value and to select one of the two revolution number candidates as the revolution number based on the detected first magnetic field value.

6. The actuator device according to claim 3, wherein, within a transition section of the rotational position angle range, the second magnetic element can be moved past the magnetic field sensor device during the drive movement, wherein the transition section includes a transition from one revolution of the rotary movement part to the next revolution, and the evaluation unit is configured to determine, within the transition section, the revolution number taking into account the first magnetic field value.

7. The actuator device according to claim 2, wherein the evaluation unit has a look-up table comprising a plurality of value pairs of a respective first magnetic field value and a respective second magnetic field value, as well as a plurality of rotational position values, wherein each value pair is assigned to a respective rotational position value, and wherein the evaluation unit is configured to determine the unambiguous rotational position using the look-up table.

8. The actuator device according to claim 1, wherein the first magnetic field value is based on a first magnetic field component and a second magnetic field component, and the second magnetic field value is based on a third magnetic field component, wherein the first magnetic field component, the second magnetic field component, and the third magnetic field component are oriented orthogonally to each other.

9. The actuator device according to claim 8, wherein the first magnetic field component and the second magnetic field component are oriented orthogonally to an axis of rotation of the rotary movement part and/or the third magnetic field component is oriented in the axial direction of the axis of rotation of the rotary movement part.

10. The actuator device according to claim 1, wherein the magnetic field sensor device is a magnetic field sensor element.

11. The actuator device according to claim 1, wherein the drive arrangement is a rack and pinion gear, the rotary movement part comprises a gear wheel and the linear movement part comprises a rack engaging with the gear wheel.

12. A method of operating an actuator device according to claim 1, comprising the steps:
performing the drive movement,
detecting the magnetic fields of the first magnetic element and the second magnetic element with the magnetic field sensor device, and
determining the unambiguous rotational position using the evaluation unit based on the detected magnetic fields.

13. The actuator device according to claim 1, wherein the actuator device is a pneumatic swivel drive.

14. The actuator device according to claim 1, wherein the actuator device is a pneumatic gripper.

15. The actuator device according to claim 10, wherein the magnetic field sensor element is a 3D Hall sensor.
